(19) United States
(12) Patent Application Publication
(10) Pub. No.: US 2018/0270238 A1
(43) Pub. Date: Sep. 20, 2018

(54) HOUSEHOLD APPLIANCE AND RELATED CONTROL METHODS

(71) Applicant: Haier US Appliance Solutions, Inc., Wilmington, DE (US)

(72) Inventor: Mark William Thomas Worley, Louisville, KY (US)

(21) Appl. No.: 15/463,661

(22) Filed: Mar. 20, 2017

(51) Int. Cl. H04L 29/06; G05B 15/02

(52) U.S. Cl. CPC H04L 63/10; G05B 2219/2642; G05B 15/02

(57) ABSTRACT

A method of operating an appliance includes receiving a request to activate the appliance, providing a prompt for authorization via a remote user interface on a separate device external to the appliance, obtaining a response to the prompt for authorization from the separate device external to the appliance, and activating the appliance when an affirmative response is obtained. Activating the appliance when an affirmative response is obtained may include full or limited operating capabilities. The method may further include activating the appliance with limited operating capabilities when an intermediate response is obtained. The method may also further include denying activation of the appliance when a negative response is obtained.

### FIELD OF THE INVENTION

The present subject matter relates generally to household appliances, and related methods of controlling or restricting usability of household appliances.

### BACKGROUND OF THE INVENTION

Household appliances may have undesirable effects when the appliances are operated improperly. For example, such undesirable effects may occur when household appliances are operated by someone who is unfamiliar with correct procedures for operating the appliances and/or who lacks the requisite physical or mental capacity to use the appliances safely.

Accordingly, there is a need for appliances which permit the primary user to prevent or limit other users' ability to operate the appliances.

### BRIEF DESCRIPTION OF THE INVENTION

A method of operating an appliance includes generating a request to activate the appliance, providing a prompt for authorization to a remote user interface on a separate device external to the appliance, obtaining a response to the prompt for authorization from the separate device external to the appliance, and activating the appliance when an affirmative response is obtained. Activating the appliance when an affirmative response is obtained may include full or limited operating capabilities. The method may further include activating the appliance with limited operating capabilities when an intermediate response is obtained. The method may also further include denying activation of the appliance when a negative response is obtained. Additional aspects and advantages of the invention will be set forth in part in the following description, or may be obvious from the description, or may be learned through practice of the invention.

In one aspect of the present disclosure, a method of operating an appliance is provided. The method includes generating a request to activate the appliance and providing a prompt for authorization to a remote user interface on a separate device external to the appliance. The method further includes obtaining a response to the prompt for authorization from the separate device external to the appliance, and activating the appliance when an affirmative response is obtained.

In another aspect of the present disclosure, an appliance is provided. The appliance includes a cabinet defining a vertical direction, a lateral direction and a transverse direction that are mutually perpendicular. The appliance further includes a controller. The controller is configured to receive a request to activate the appliance and to provide a prompt for authorization to a separate user interface on a separate device external to the appliance. The controller is further configured to obtain a response to the prompt for authorization from the separate device external to the appliance and to activate the appliance when an affirmative response is obtained.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a dryer appliance in accordance with an example embodiment of the present disclosure;

FIG. 2 provides a perspective view of an oven appliance in accordance with an example embodiment of the present disclosure;

FIG. 3 provides a perspective view of a microwave oven appliance in accordance with an example embodiment of the present disclosure;

FIG. 4 provides a perspective view of a refrigeration appliance in accordance with an example embodiment of the present disclosure; and

FIG. 5 is a flow chart illustrating a method of operating an appliance in accordance with embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Features of the present disclosure may be provided with any household appliance where desired. For example and without limitation, the following description refers to several possible example appliances, as set forth in more detail below. Additional and further example appliances which may include features of the present disclosure are also possible, including but not limited to a water heater, water filter or purifier, an air conditioner, a space heater, among many other examples.

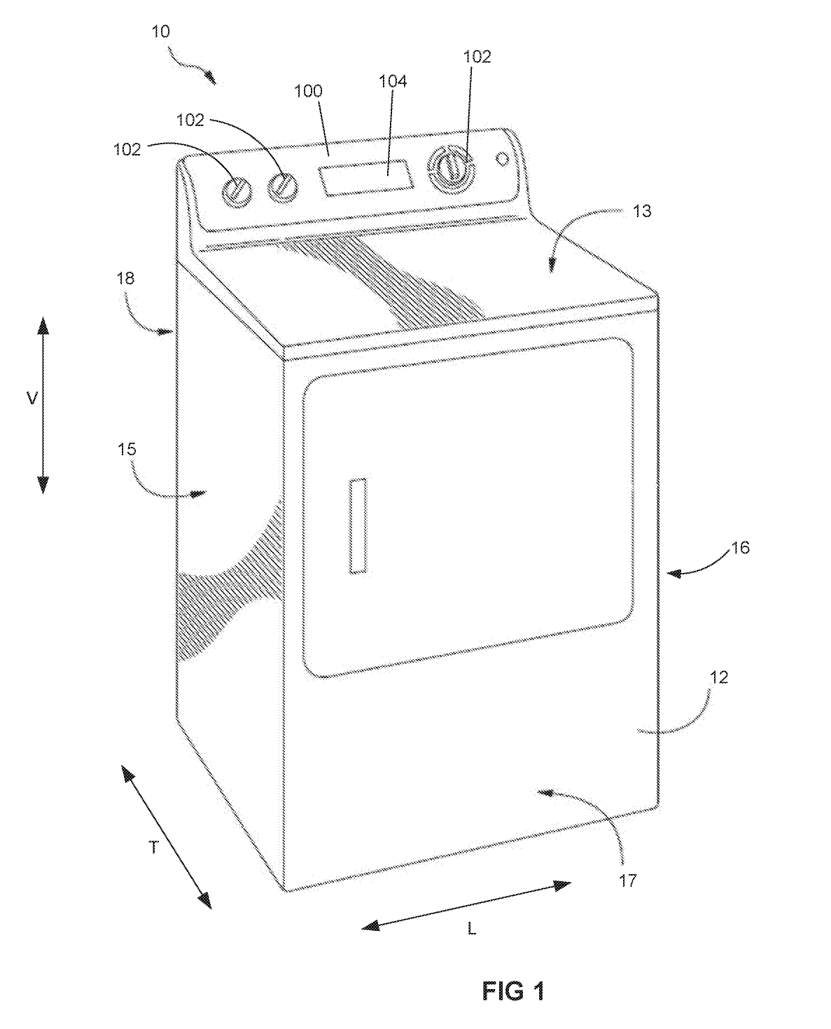

As may be seen in FIGS. 1 through 4, in accordance with one or more embodiments of the present subject matter, an appliance 10 having a cabinet 12 is provided. The cabinet 12 defines a vertical direction V, a lateral direction L, and a transverse direction T that are mutually perpendicular. The cabinet 12 extends between a top portion 13 and a bottom portion 14 along the vertical direction V. Cabinet 12 also extends between a first side portion 15 and a second side portion 16, e.g., along the lateral direction L, and a front portion 17 and a back portion 18, e.g., along the transverse direction T.

In the particular example of FIG. 1, the appliance 10 may be a laundry appliance, e.g., the appliance may be a dryer 10. While described in the context of a specific embodiment of dryer appliance 10, using the teachings disclosed herein, it will be understood that dryer appliance 10 is provided by way of example only. Other dryer appliances having different appearances and different features may also be utilized with the present subject matter as well.

The exemplary dryer appliance 10 of FIG. 1 may include a drum or container (not shown) mounted within the cabinet 12 for rotation about a substantially horizontal axis. The drum may define a chamber for receipt of articles, e.g., clothing, for drying. The drum is also in fluid communication with a heating assembly or system, such as via a supply duct that receives heated air from the heating assembly. For example, the heating assembly may include a heating element, such as a gas burner, an electrical resistance heating element, or heat pump, for heating air. The particular structure of the drum and heating system are understood by those of skill in the art and are not described in further detail herein.

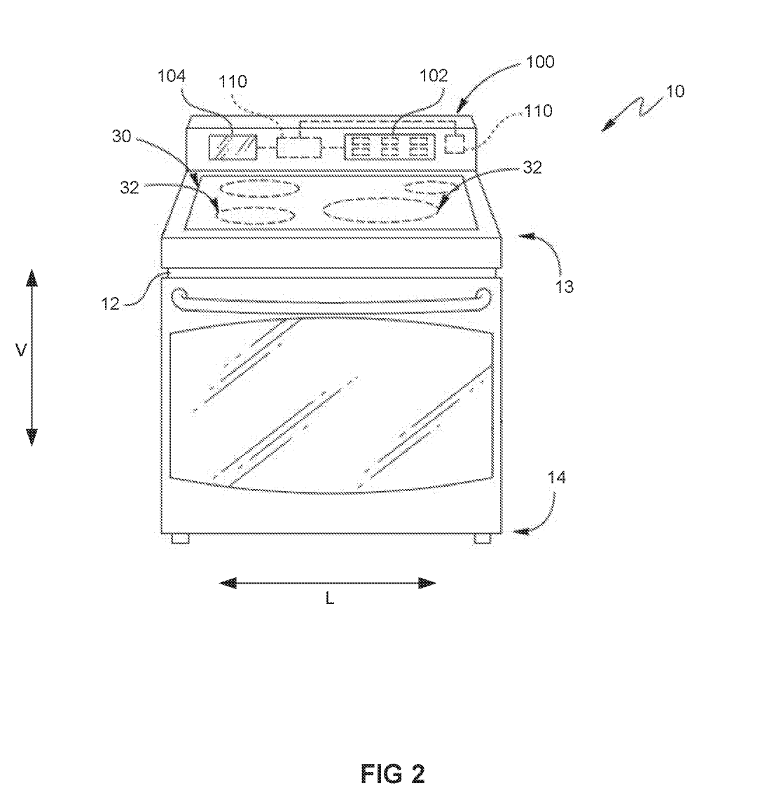

FIG. 2 illustrates another example embodiment of the appliance 10, wherein the appliance 10 is an oven appliance including a cooktop and an oven. The exemplary oven appliance 10 illustrated in FIG. 2 includes user interface panel 100 and user input device 102. In the illustrated example of FIG. 2, the user input device 102 is a touch screen interface. Oven appliance 10 is provided by way of example only and is not intended to limit the present subject matter in any aspect. Thus, the present subject matter may be used with other oven appliance configurations, e.g., that define one or more interior cavities for the receipt of food and/or having different heating element arrangements than what is shown in FIG. 2. Further, the present subject matter may be used in a stand-alone cooktop, a hot plate, or any other suitable appliance.

As illustrated in FIG. 2, the exemplary oven appliance 10 generally includes a cooking assembly. The cooking assembly may include one or more heating elements. For example, in some embodiments, the cooking assembly, and thus the oven appliance 10 includes cabinet 12 which in some embodiments may be an insulated cabinet 12 with an interior cooking chamber (not shown) configured for the receipt of one or more food items to be cooked defined within insulated cabinet 12. Such cooking chambers are generally understood by those of ordinary skill in the art and are not described in further detail herein. The oven appliance 10 may additionally include a cooktop 30. Cooktop 30 may be disposed on the cabinet 12 generally at or proximate to top portion 13. Cooktop 30 includes one or more heating assemblies 32, e.g., electric heating elements or gas burners, thereon.

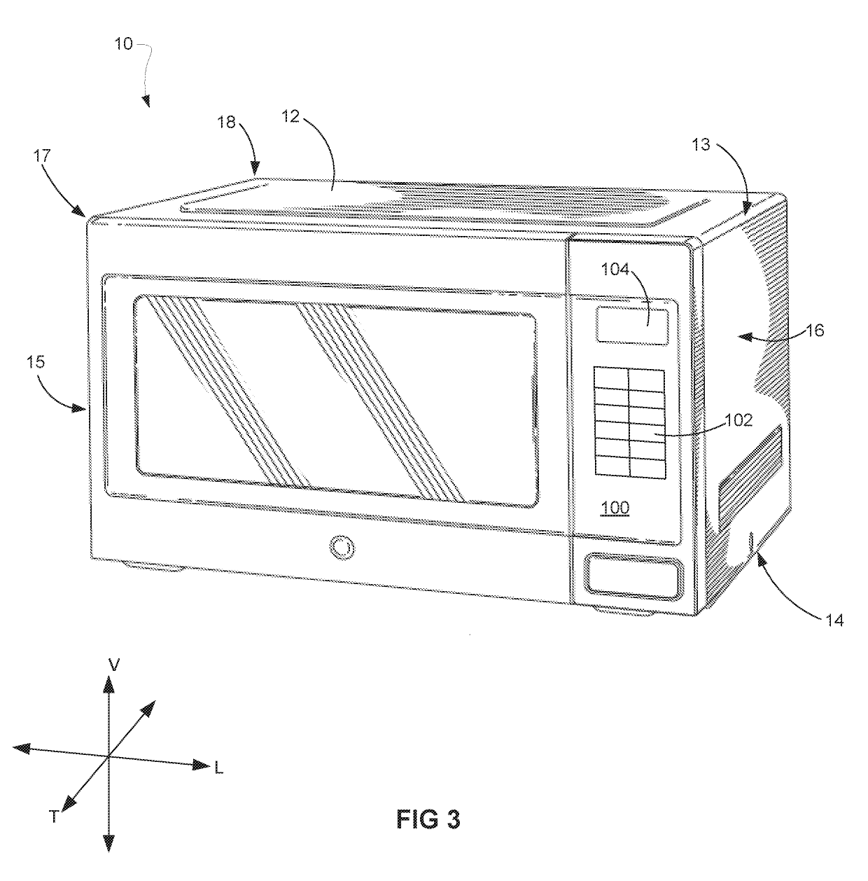

In another example embodiment, the appliance 10 may be a microwave oven appliance, such as is illustrated in FIG. 3. It should be understood that microwave oven appliance 10 is provided by way of example only. Thus, the present subject matter is not limited to microwave oven appliance 10 and may be utilized in any suitable appliance.

Microwave oven appliance 10 includes a cabinet 12. A cooking chamber is defined within the cabinet 12 of the microwave 10. Microwave 10 of FIG. 3 is configured to heat articles, e.g., food or beverages, within the cooking chamber using electromagnetic radiation. Microwave appliance 10 may include various components which operate to produce the electromagnetic radiation, as is generally understood. For example, microwave appliance 10 may include a magnetron (such as, for example, a cavity magnetron), a high voltage transformer, a high voltage capacitor and a high voltage diode. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to the cooking chamber. The structure and intended function of microwave ovens are generally understood by those of ordinary skill in the art and are not described in further detail herein.

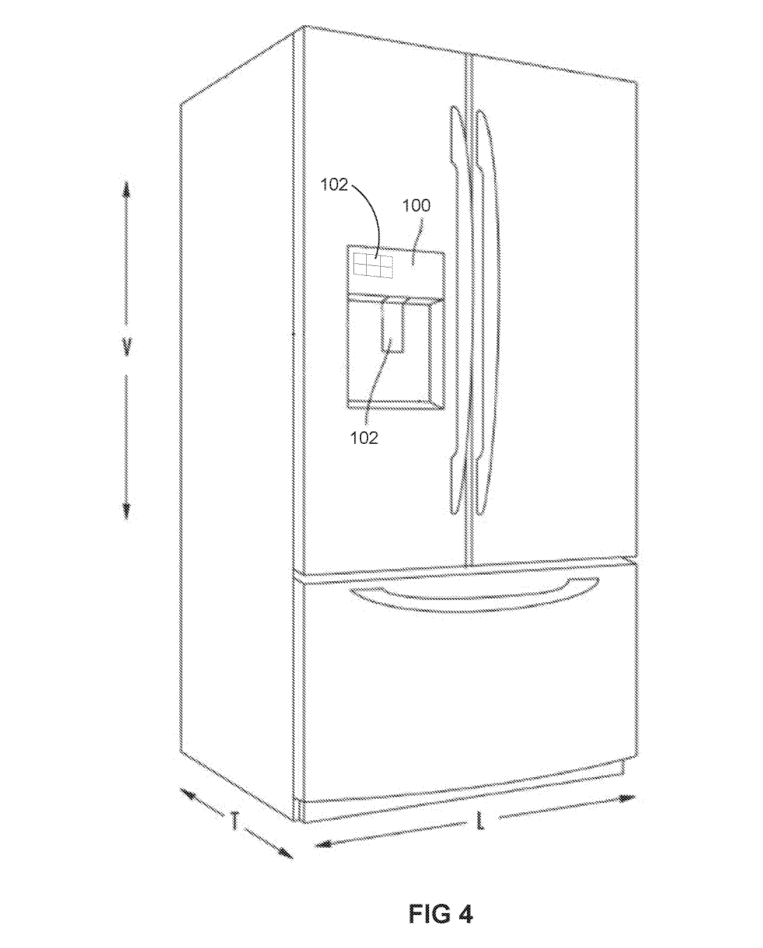

In another example embodiment, the appliance 10 may be a refrigeration appliance, such as is illustrated in FIG. 4. Refrigerator appliance 10 is generally referred to as a bottom-mount refrigerator appliance. It should be understood that refrigeration appliance 10 is provided by way of example only. Thus, the present subject matter is not limited to refrigeration appliance 10 and may be utilized in any suitable appliance.

Still referring to FIG. 4, the refrigeration appliance may include a dispenser 100, which may be configured to dispense cold water, hot water, and/or ice. As illustrated, dispenser may include a dispenser recess defined on one of the refrigerator doors. The dispenser may include one or more outlets for dispensing ice, chilled liquid water, and/or heated liquid water. Dispenser may, for example, include a paddle mounted below the one or more outlets. As illustrated, a single paddle may be provided in connection with a control panel or user interface for controlling the mode of operation of dispenser, e.g., for selecting chilled liquid water, heated liquid water, crushed ice, and/or whole ice. User interface panel may include a chilled water dispensing button (not labeled), an ice-dispensing button (not labeled) and a heated water dispensing button (not labeled) for selecting between chilled liquid water, ice, and heated liquid water, respectively. The particular structure and operation of the refrigerator and dispensing system are understood by those of skill in the art and are not described in further detail herein.

According to various embodiments of the present disclosure, the appliance 10 may take the form of any of the examples described above, or may be any other household appliance where the ability to remotely monitor or restrict usage of the appliance is desired. Thus, it will be understood that the present subject matter is not limited to any particular appliance.

Referring again to the various embodiments illustrated in FIGS. 1 through 4, a user interface panel 100 and a user input device 102 may be positioned on an exterior of the cabinet 12. The user input device 102 is generally positioned proximate to the user interface panel 100, and in some embodiments, the user input device 102 may be positioned on the user interface panel 100. Generally, the appliance 10 may include a controller 110 in operative communication with the user input device 102. One or more user input devices 102, such as knobs, buttons, touchscreen interfaces, etc., may be provided or mounted on the user interface panel 100. Signals generated in controller 110 operate appliance 10 in response to user input via the user input devices 102. In the example illustrated in FIG. 1, a plurality of user input devices 102 are provided as knobs. In the example illustrated in FIG. 2, user input device 102 is provided as a touch screen type interface. As a further example illustrated in FIG. 3, user input devices 102 are provided as a touch pad. In the example illustrated in FIG. 4, the user interface may be or include a dispenser 100, and user input devices 102 may include a paddle 102 and/or buttons 102. In other embodiments, various combinations are possible, e.g., the dryer appliance 10 of FIG. 1 may have a touch screen 102 as in FIG. 2 or a touch pad 102 as in FIG. 3. The foregoing user input devices 102 are provided as examples only and are not limiting, various other user input devices 102 may be provided.

The user interface panel 100 may represent a general purpose Input/Output (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user.

The user interface panel 100 of the appliance 10 may be in communication with the controller 110 via, for example, one or more signal lines or shared communication busses. Input/Output (“I/O”) signals may be routed between controller 110 and various operational components of the appliance 10. Operation of the appliance 10 can be regulated by the controller 110 that is operatively coupled to the user interface panel 100. A user interface panel 100 may for example provide selections for user manipulation of the operation of an appliance, e.g., via user input device 102. In response to user manipulation of the user interface panel 100 and/or user input device 102, the controller 110 may operate various components of the appliance 10. Controller 110 is a “processing device” or “controller” and may be embodied as described herein. Controller 110 may include a memory and one or more microprocessors, microcontrollers, application-specific integrated circuits (ASICS), CPUs or the like, such as general or special purpose microprocessors operable to execute programming instructions or micro-control code associated with operation of the appliance 10, and controller 110 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 110 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 110 may be programmed to operate the appliance 10 by executing instructions stored in memory. For example, the instructions may be software or any set of instructions that when executed by the processing device, cause the processing device to perform operations. Controller 110 can include one or more processor(s) and associated memory device(s) configured to perform a variety of computer-implemented functions and/or instructions (e.g. performing the methods, steps, calculations and the like and storing relevant data as disclosed herein). It should be noted that controllers 110 as disclosed herein are capable of and may be operable to perform any methods and associated method steps as disclosed herein.

The appliance 10, and in particular, controller 110 thereof, may be configured to communicate (e.g. using a wired or wireless connection) with a separate device external to the appliance, such as a communications device. The communications device may be a laptop computer, smartphone, tablet, personal computer, wearable device, smart home system, and/or various other suitable devices. The appliance 10 may be in communication with the separate communications device through various possible communication connections and interfaces. For purposes of the description herein, possible wired or wireless communication connections and interfaces can include, but are not limited to, wireless radio, WI-FI®, BLUETOOTH®, ZIGBEE®, laser, infrared, and Ethernet type devices and interfaces.

The separate device may include a memory for storing and retrieving programming instructions. Thus, some embodiments may include a remote user interface separate and apart from the appliance 10 itself, and the remote user interface may be an additional user interface to the user interface panel 100. For example, the separate device may be a smartphone operable to store and run applications, also known as “apps,” and the remote user interface may be provided as a smartphone app.

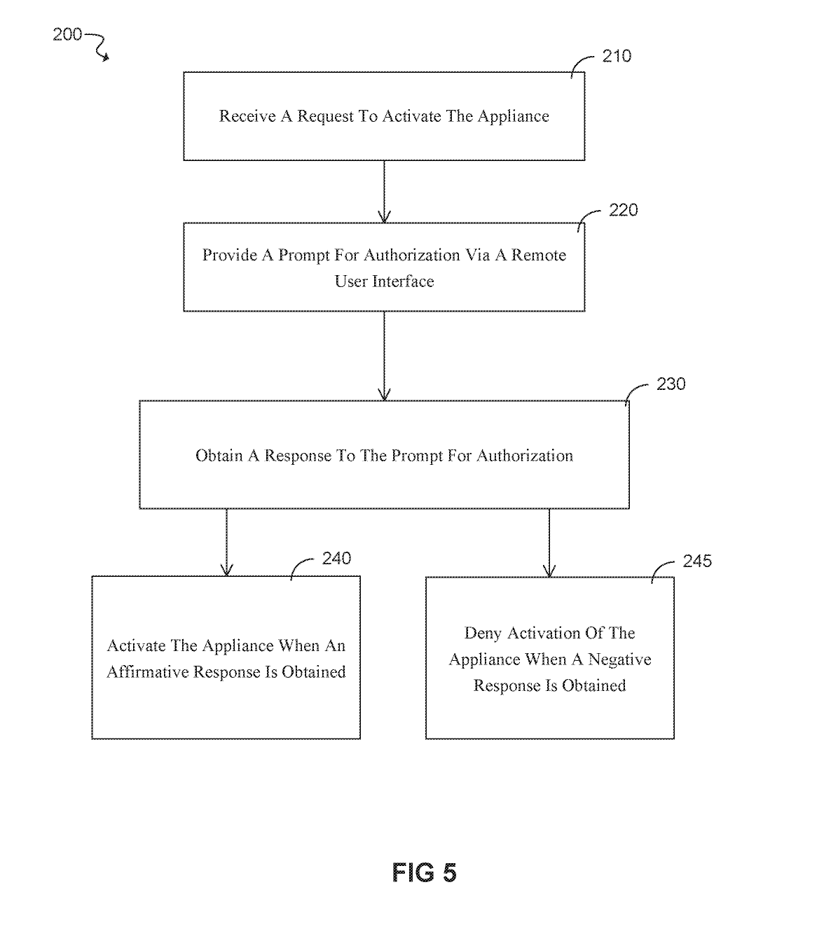

As illustrated in FIG. 5, some embodiments include a method 200 of operating an appliance 10. The method 200 includes a step 210 of receiving a request to activate the appliance 10. In some embodiments, the request to activate the appliance 10 may be a remote request received without physical interaction between a user and the appliance, e.g., when the appliance 10 is an oven appliance, the remote request may include a remote request to preheat the oven. For example, the remote request may be initiated via a communications device such as a smartphone or a smart home system. In such embodiments, the method 200 may include verifying a user is present prior to activating the appliance, such as by verifying that a user input device 102 physically connected to the appliance has been manipulated, e.g., that a knob has been turned or a button has been pressed. In other embodiments, the request to activate the appliance 10 may be received via the user interface panel 100 and/or user input device 102. For example, the request to activate the appliance 10 may be initiated by a first user via user input device(s) 102. The physical presence of a user, e.g., the first user, thus may be confirmed from the manipulation of user input device(s) 102, where the user input device(s) 102 is or are physically connected to the appliance. However, the identity of the first user as well as his or her authorization to operate the appliance 10 are not confirmed solely by the first user's manipulating the user input device(s) 102. Thus, authorization to operate the appliance 10 may be obtained via a remote user interface. For example, method 200 may include a step 220 of providing a prompt for authorization via a remote user interface on a separate device external to the appliance. In some embodiments, the separate device external to the appliance 10 may be a smartphone, the remote user interface may be a smartphone app, and the prompt for authorization may be a notification or text message sent to the smartphone.

Method 200 may further include a step 230 of obtaining a response to the prompt for authorization. For example, where the remote user interface is a smartphone app, the response may be obtained from a second user, e.g., the owner of the smartphone app, where the owner or user of the smartphone app is presumed to be the owner or primary user of the appliance 10 or otherwise fully authorized to operate the appliance 10. In some instances, the first user and the second user may be the same person, where the only distinction is the user interface or input device through which the user interacts with the appliance 10. In various embodiments, the response may be a binary response, e.g., yes or no only, or the prompt may permit the user to provide a wider range of responses. The possible responses will generally include at least an affirmative response and a negative response, and may also include additional options, as further described herein.

In various embodiments, a binary choice may be available for the response to the prompt for authorization, which may include any two of the three options, e.g., full authorization, limited authorization, or full denial. For example, in some embodiments, the controller 110 may be configured to permit full operation when the affirmative response is obtained and, when the negative response is obtained, may permit limited operation or may deny activation of the appliance. In another example, the controller 110 may be configured to activate the appliance 10 with limited operating capabilities when the affirmative response is obtained and to deny activation of the appliance 10 when the negative response is obtained. It is also possible for the prompt to include all three options as possible responses, such as selections within a menu, wherein the response to the prompt for authorization may include one of an intermediate response, the affirmative response, or the negative response. In any of the foregoing examples, limited authorization and/or permitting limited operation may correspond to activating the appliance with limited operating capabilities such that only certain functions or operating ranges are active while other functions or operating ranges are deactivated, whereas permitting full operation of the appliance includes activating the appliance with its full range of operating capabilities and/or functions activated and available. As described in more detail below, in various exemplary embodiments, activating the appliance with limited operating capabilities means providing less than all of the appliance's possible functions, such as disabling high heat mode in a dryer appliance, and/or operating ranges, such as limiting time or temperature settings in a cooking appliance.

The request to activate the appliance 10 at step 210 may include requested operating parameters. The requested operating parameters may be requested via user input device 102. For example, the requested operating parameters may include a time parameter and/or a temperature parameter. The prompt for authorization of step 220 may include additional information, such as the requested operating parameters. In such embodiments, the response may take various forms, such as full authorization which permits a user to operate the appliance 10 over its full range of capabilities and settings, a limited or qualified authorization which permits the user to operate the appliance 10 over a limited range of its capabilities and settings, or a full denial, which completely denies activation of the appliance. For example, the prompt for authorization of step 220 may include the requested operating parameters and provide for a binary response such as an affirmative response which permits operation of the appliance at the requested operating parameters or a negative response which denies operation of the appliance. Thus, in some cases, after a negative response is obtained, the requested operating parameters may be adjusted and a new request to activate the appliance 10 may be initiated with the adjusted operating parameters. In another example, the prompt for authorization of step 220 may include the requested operating parameters and provide for possible responses including permitting operation of the appliance 10 at the requested operating parameters, permitting operation of the appliance 10 at different operating parameters than the requested operating parameters, or denying activation of the appliance 10. For example, the request to activate the appliance 10 may include a request to activate the appliance at a first time parameter, and a possible response to the prompt for authorization may include permitting operation of the appliance 10 at a second, lower time parameter. As another example, in embodiments wherein the appliance 10 is a refrigeration appliance 10 as illustrated in FIG. 4 and is configured to dispense hot water, a requested operating parameter may include a request to dispense hot water, and possible responses may include a qualified authorization, e.g., permitting water to be dispensed, but with a lower temperature parameter, e.g., cold water.

Method 200 may further include a step 240 of activating the appliance when the affirmative response is received, and/or a step 245 of denying activation of the appliance when the negative response is received. In various embodiments, activating the appliance 10 may include fully activating the appliance 10, e.g., activating the appliance 10 with full operating capabilities available, or may include activating the appliance 10 with limited operating capabilities available.

In another alternative embodiment, the prompt for authorization may provide for a tiered response. For example, the prompt for authorization may include a first binary choice between allowing or denying activation of the appliance. In such embodiments, when denying activation is selected, the method ends and the appliance 10 is disabled. However, when allowing activation is selected, the method may further include a second binary choice between full and limited activation.

In some example embodiments, an auto approve option may be provided. When selected, the auto approve option may include a predetermined time limit such that if no response the obtained within the predetermined time limit, the request to activate the appliance 10 is deemed automatically approved, and the appliance 10 may then be activated according to the various options described herein. For example, the auto approve may provide full activation or limited activation. Accordingly, in some embodiments, the disclosed method may further include activating the appliance 10 after the predetermined amount of time when a response to the prompt for authorization has not been received after the predetermined amount of time.

Various embodiments described herein include a limited activation option. Throughout such embodiments, the range of operating capabilities which are available in the limited activation mode may be predetermined or may be customizable via the remote user interface each time the limited activation mode is selectable. In one example, where the appliance 10 is a dryer, providing limited activation may include permitting the dryer to operate only in a low-heat mode or an air fluff mode, e.g., with the heating assembly at a low setting or turned off. As is understood in the art, low-heat mode or a low setting for the heating assembly is defined in relation to the maximum or full capacity of heat production, i.e., low heat is less than the full amount of heat that could be provided by the heating assembly. In another example, where the appliance 10 is an oven, providing limited activation may include disabling one or more of the heating elements 32 on the cooktop 30 of the oven 10, up to and including disabling the cooktop 30 altogether, while permitting the oven 10 to heat the cooking chamber or vice versa. For example, if the oven appliance includes digital control, disabling the cooktop 30 may include disabling a power supply to one or more burners on the cooktop 30. Additionally or in the alternative, activating the oven appliance 10 with limited operating capabilities may include heating the cooking chamber only to no more than a predetermined maximum temperature. In yet another example, where the appliance 10 is a microwave, providing limited activation of the microwave 10 may include permitting the microwave 10 to operate for no more than a predetermined maximum amount of time, e.g., one minute, two minutes, five minutes, or any other suitable maximum time. Additionally or in the alternative, activating the microwave 10 with limited operating capabilities may include permitting the microwave 10 to operate at no more than a predetermined maximum power level, e.g., fifty percent power, seventy-five percent power, or any other suitable maximum power. In any of the foregoing examples, limiting the range of operating capabilities may include providing only a single option for each user-selectable parameter. Thus, the limited activation option may provide specific configuration of the appliance 10 via the remote user interface. For example, where the appliance 10 is an oven appliance, a local user may be permitted to turn the oven ON when a premade meal is in the cooking chamber and the available range of operating capabilities permitted by the remote user may include only a single temperature parameter and a single time parameter, e.g., only three hundred fifty degrees Fahrenheit (350° F.) for thirty minutes (30 min).

In some embodiments, the requirement for remote user authorization prior to activating the appliance 10 may be manually turned on or off, e.g., via the smartphone app. In other embodiments, the requirement for remote user authorization may also or instead be based on a time of day, e.g., remote user authorization may be required at certain times of day but not others. For example, where the primary user of the appliance is a parent, the requirement for remote user authorization may be active during times of day when the parent is still at work while their child or children are home from school. In such embodiments, the method 200 may further include determining a time of day when the request to activate is received prior to providing the prompt for authorization, permitting activation of the appliance when the determined time of day falls within a first time range, and providing the prompt for authorization when the determined time of day falls within a second time range. Continuing the above example, the first time range may be after the parent comes home from work and the second time range may be after the child comes home from school but before the parent comes home from work.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an appliance, the method comprising:
generating a request to activate the appliance;
providing a prompt for authorization to a remote user interface on a separate device external to the appliance; and
activating the appliance when an affirmative response to the prompt for authorization is obtained from the separate device external to the appliance.

2. The method of claim 1, further comprising determining a time of day when the request to activate is generated prior to providing the prompt for authorization, activating the appliance when the determined time of day falls within a first time range, and providing the prompt for authorization when the determined time of day falls within a second time range.

3. The method of claim 1, wherein activating the appliance when the affirmative response is obtained comprises activating the appliance with limited operating capabilities and the method further comprises denying activation of the appliance when a negative response is obtained.

4. The method of claim 1, wherein activating the appliance when the affirmative response is obtained comprises activating the appliance with full operating capabilities, and the method further comprises denying activation of the appliance when a negative response is obtained.

5. The method of claim 1, wherein activating the appliance when the affirmative response is obtained comprises activating the appliance with full operating capabilities, and the method further comprises activating the appliance with limited operating capabilities when a negative response is obtained.

6. The method of claim 5, wherein the appliance is a dryer appliance, and wherein activating the appliance with limited operating capabilities comprises permitting the dryer to operate only in a low-heat mode or an air fluff mode.

7. The method of claim 5, wherein the appliance is a microwave, and wherein activating the appliance with limited operating capabilities comprises permitting the microwave to operate for no more than a predetermined maximum amount of time.

8. The method of claim 5, wherein the appliance is an oven, and wherein activating the appliance with limited operating capabilities comprises disabling a cooktop of the oven and permitting the oven to operate at no more than a predetermined maximum temperature.

9. The method of claim 1, wherein activating the appliance when the affirmative response is obtained comprises activating the appliance with full operating capabilities, and the method further comprises activating the appliance with limited operating capabilities when an intermediate response is obtained and denying activation of the appliance when a negative response is obtained.

10. The method of claim 1, wherein receiving a request to activate the appliance includes receiving requested operating parameters, and the method further comprises providing information about the requested operating parameters with the prompt for authorization.

11. The method of claim 1, wherein the request to activate is generated at the appliance in response to manipulation of a user input device physically connected to the appliance.

12. The method of claim 1, wherein the request to activate the appliance is a remote request received without physical interaction between a user and the appliance.

13. The method of claim 12, further comprising verifying a user is present prior to activating the appliance.

14. The method of claim 13, wherein verifying the user is present comprises verifying that a user input device physically connected to the appliance has been manipulated.

15. The method of claim 1, further comprising activating the appliance after a predetermined amount of time when a response to the prompt for authorization has not been received after the predetermined amount of time.

16. An appliance, comprising:
a cabinet defining a vertical direction, a lateral direction and a transverse direction that are mutually perpendicular; and
a controller configured to receive a request to activate the appliance, to obtain a response to a prompt for authorization from a separate device external to the appliance, and to activate the appliance when an affirmative response is obtained.

17. The appliance of claim 16, wherein the controller is configured to activate the appliance with limited operating capabilities when the affirmative response is obtained.

18. The appliance of claim 17, wherein the appliance is a dryer appliance, and wherein limited operating capabilities comprise permitting the dryer to operate only in a low-heat mode or an air fluff mode.

19. The appliance of claim 17, wherein the appliance is a microwave, and wherein limited operating capabilities comprise permitting the microwave to operate for no more than a predetermined maximum amount of time.

20. The appliance of claim 17, wherein the appliance is an oven, and wherein limited operating capabilities comprise disabling a cooktop of the oven and permitting the oven to operate at no more than a predetermined maximum temperature.
